(19) United States
(12) Patent Application Publication
(10) Pub. No.: US 2019/0241777 A1
(43) Pub. Date: Aug. 8, 2019

(54) ADHESIVES AND SEALANTS HAVING MICROCELLULAR STRUCTURES FORMED WITHIN

(71) Applicant: Zephyros, Inc., Romeo, MI (US)

(72) Inventor: Michael Czaplicki, Rochester Hills, MI (US)

(21) Appl. No.: 16/268,644

(22) Filed: Feb. 6, 2019

Related U.S. Application Data
(60) Provisional application No. 62/626,951, filed on Feb. 6, 2018.

(51) Int. Cl. C09J 163/00; C09J 9/00; C09J 123/06; C08J 9/10

(52) U.S. Cl. CPC C09J 163/00; C09J 9/00; C09J 123/06; C08J 9/103; C08J 9/107; C08J 2363/00; C08J 2201/03; C08J 2203/04; C08J 2203/182; C08J 2203/184; C08J 2207/02; C08J 9/105

(57) ABSTRACT

A material for sealing, adhering, or structural reinforcement or some combination thereof, comprising a primary blowing agent for imparting cellular structures within the material during initial manufacturing of the material, a polymeric base material that has adhesive characteristics, sealing characteristics, or some combination thereof, a curing agent for curing the material via a stimulus, and optionally a secondary blowing agent for forming additional cellular structures within the material.

### TECHNICAL FIELD

The present invention relates generally to adhesives and sealants formulated to contain microcellular structures prior to activation.

### BACKGROUND

A variety of industries utilize polymer-based materials for sealing and adhering. The use of adhesives and sealants is widespread in the automotive and construction industries as well as in certain consumer product industries such as sporting equipment, shoes, furniture and other goods where strong adhesion and/or sealing is necessary. These materials are often activatable, meaning that they are formulated to expand and/or cure upon contact with a stimulus.

There is also an ongoing desire to manufacture structures that are lighter, making foamable materials preferable. Such light-weighting is simplified when less material is needed for sufficient sealing/adhesion. It is also desirable for sealant and adhesive materials that foam with the use of minimal chemical blowing agents, as some chemical blowing agents may have negative environmental impacts.

Notwithstanding the above, there remains a need for foamable adhesives and sealants where less material is needed and the amount of agents for causing foaming is minimized.

### SUMMARY OF THE INVENTION

One or more of the above needs are met by the present teachings including a material comprising a primary blowing agent for causing the formation of cellular structures within the material during an initial manufacturing process, and a secondary blowing agent for causing the formation of cellular structures within the material after the initial manufacturing process.

The teachings herein further provide for a material comprising a primary blowing agent for causing the formation of cellular structures within the material during an initial manufacturing process, an epoxy material and a curing agent.

The material may include a secondary blowing agent that may be activated by a selected stimulus (e.g., heat, UV light, moisture). The primary blowing agent may be selected from a physical blowing agent or a chemical blowing agent. The primary blowing agent may be limited to physical blowing agents and may be free of any chemical blowing agents. The primary blowing agent may be selected from hydrocarbons, chlorofluorocarbons, nitrogen, carbon dioxide, and combinations thereof. The initial manufacturing process may be an extrusion process. The primary blowing agent may be less than about 10%, less than about 5%, or even less than about 2.5% by weight of the material. The material may be an activatable material that expands or cures after manufacture. The material may include a secondary blowing agent that is a chemical blowing agent. The secondary blowing agent may be selected from azodicarbonamide, dinitrosopentamethylenetetramine, azodicarbonamide, dinitrosopentamethylenetetramine, 4,4ioxy-bis-(benzenesulphonylhydrazide), trihydrazinotriazine and N,Ni-dimethyl-N,Nidinitrosoterephthalamide and combinations thereof. The material may include a toughening agent. The toughening agent may be a core shell material.

The teachings herein also provide for a material for sealing or structural reinforcement or some combination thereof, comprising a primary blowing agent for imparting cellular structures within the material during initial manufacturing of the material, a polymeric base material that has adhesive characteristics, sealing characteristics, or some combination thereof, a curing agent for curing the material via a stimulus, and optionally a secondary blowing agent for forming additional cellular structures within the material.

The polymeric base material may be an epoxy-based material. The polymeric base material may be an ethylene-based material. The primary blowing agent may be a physical blowing agent. The secondary blowing agent may be a chemical blowing agent. The secondary blowing agent may be a physical blowing agent.

### DETAILED DESCRIPTION

The present teachings meet one or more of the above needs by the improved processes and materials described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 62/626,951, filed Feb. 6, 2018, the contents of that application being hereby incorporated by reference for all purposes.

The description herein addresses activatable materials that may be adhesives in nature, sealants in nature or have some combination of adhesive and sealant characteristics. The activatable material may be considered structural in nature such that upon activation and/or cure, the material is capable of providing structural support. The material may also be adapted to have sound attenuation capabilities. As used herein the phrase adhesive/sealant is defined to encompass materials that are adhesive in nature, sealing in nature, structural in nature, or some combination thereof.

As noted above, the methods may involve using a blowing agent (e.g. a primary blowing agent). In one example, a physical blowing agent may be introduced into a stream of a component material of an adhesive or sealant during a molding, extrusion or other manufacturing process. In another example, a chemical blowing agent may be used. The chemical blowing agent may be used along with, or instead, of a physical blowing agent. The chemical blowing agents may be blended with, or added to, material pellets or otherwise introduced into the stream of one or more components of the adhesive or sealant.

In the event that a physical blowing agent is used, the physical blowing agent can be introduced from a blowing agent source. A wide variety of physical blowing agents may be utilized such as hydrocarbons, chlorofluorocarbons, nitrogen, carbon dioxide, and combinations thereof. It is possible that carbon dioxide, or nitrogen, or a mixture thereof is utilized as the blowing agent.

Carbon dioxide may be used in combination with other blowing agents such as nitrogen, or carbon dioxide may be used alone with no other blowing agents present. In other embodiments carbon dioxide can be used with other blowing agents so long as the other blowing agents do not materially alter the blowing process. When nitrogen is used, similarly it can be used alone, in combination with another blowing agent (e.g. carbon dioxide) that adds to or changes the blowing agent properties, or in combination with another agent that does not materially change the blowing process.

It is possible that resulting foamed adhesive or sealants may be substantially free of residual chemical blowing agents or by-product of chemical blowing agent.

The blowing agent is generally less than about 10% by weight of an adhesive or sealant stream and blowing agent. It is possible that the blowing agent may be less than about 5% by weight of the adhesive/sealant stream and blowing agent. It is possible that the blowing agent may be less than about 2.5% by weight of the adhesive/sealant stream and blowing agent. The blowing agent may be less than about 1% by weight of the adhesive/sealant stream and blowing agent. A metering device may be used to meter the blowing agent so as to control the amount of the blowing agent in the adhesive or sealant component stream to maintain a level of blowing agent at a particular level.

When carbon dioxide is used as a blowing agent, it may be possible to use relatively low amounts of blowing agent such as less than about 2.5%, or less than about 1%, by weight of the adhesive/sealant stream. When nitrogen is used as a blowing agent, it may be possible to use very low amounts of blowing agent such as less than about 1.0%, less than about 0.5%, or less than about 0.1%, by weight of adhesive/sealant stream.

In general, as described further below, use of selected fillers (e.g., talc) may enable lower blowing agent percentages.

Manufacturing processes described herein have been described in U.S. Pat. No. 6,284,810 which is incorporated herein by reference for all purposes.

A single-phase solution of blowing agent and adhesive/sealant may be formed in in the extruder, molding device, or other device. Formation of a single-phase solution may be particularly conducive to forming a foam structure having relatively small cell sizes, as described further below. The single-phase solution may form cells upon being extruded through a die. For example, the solution may experience a rapid pressure drop which induces formation of cells when passing through the die.

It is also possible that a mixture of blowing agent and adhesive/sealant which is not a single-phase solution may be utilized. Such solutions may not be as well-suited for forming small cell foams and/or foams having small aspect ratios.

Epoxy-based materials can be particularly suitable for the adhesive/sealant materials of the present teachings. Epoxy resin is used herein to mean any of the conventional dimer, oligomer or polymer epoxy materials containing at least one epoxy functional group. The polymer based materials may be epoxy containing materials having one or more oxirane rings polymerizable by a ring opening reaction. It is possible that the adhesive/sealant material includes up to about 80% of an epoxy resin. More preferably, the adhesive/sealant includes between about 10% and 50% by weight of epoxy containing materials.

The epoxy containing materials may be aliphatic, cycloaliphatic, aromatic or the like. The epoxy may be supplied as a solid (e.g., as pellets, chunks, pieces or the like) or a liquid (e.g., a liquid epoxy resin) or both. The epoxy may be blended with one or more ethylene copolymers or terpolymers that may possess an alpha-olefin. As a copolymer or terpolymer, the polymer is composed of two or more different monomers, i.e., small chemically reactive molecules that are capable of linking up with each other or similar molecules. Preferably, an epoxy resin is added to the adhesive/sealant material to increase the flow properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive.

One or more of the epoxy containing materials may be provided to the adhesive/sealant material as an epoxy/elastomer hybrid, e.g., a blend, copolymer or adduct that has been previously fabricated. The epoxy/elastomer hybrid, if included, may be included in an amount of up to about 90% by weight of the adhesive/sealant material. Typically, the epoxy/elastomer hybrid is approximately from about 1% to about 50% and more typically is approximately from about 5% to about 20% by weight of the adhesive/sealant material.

In turn, the epoxy elastomer itself generally includes about 1:5 to 5:1 parts of epoxy to elastomer, and more preferably about 1:3 to 3:1 parts of epoxy to elastomer. In one preferred embodiment, the epoxy/elastomer hybrid preferably includes approximately from about 40% to about 80% of an epoxy resin (such as disclosed in the above), and from about 20% to about 60% of an elastomer compound. The elastomer compound may be any suitable art disclosed thermoplastic elastomer, thermosetting elastomer or a mixture thereof. Exemplary elastomers include, without limitation natural rubber, styrenebutadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed.

The epoxy/elastomer hybrid, when added to the adhesive/sealant material, preferably is added to modify structural properties of the adhesive/sealant material such as strength, toughness, stiffness, flexural modulus, or the like. Additionally, the epoxy/elastomer hybrid may be selected to render the adhesive/sealant material more compatible with coatings such as water-borne paint or primer system or other conventional coatings.

Rubber or an elastomer may also be added to the adhesive/sealant material as a separate ingredient. Again, the elastomer compound may be a thermoplastic elastomer, thermosetting elastomer or a mixture thereof or otherwise. Exemplary elastomers include, without limitation, natural rubber, styrene-butadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed. The elastomer or rubber, whether added as part of a hybrid or adduct or on its own, may be a substantial portion of the adhesive/sealant material. The elastomer or rubber can be at least 10%, more typically at least 20% and possibly at least 35% or at least 55% by weight of the adhesive/sealant.

It is possible that one or more polymers may be incorporated into the adhesive/sealant material, e.g., by copolymerization, by blending, or otherwise. For example, without limitation, other polymers that might be appropriately incorporated into the adhesive/sealant material include halogenated polymers, polycarbonates, polyketones, urethanes, polyesters, silanes, sulfones, allyls, olefins, styrenes, acetates, ethylene vinyl acetates, acrylates, methacrylates, epoxies, silicones, phenolics, rubbers, polyphenylene oxides, terphthalates, or mixtures thereof. Other potential polymeric materials may be or may include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methylmethacrylate), poly(vinyl acetate), poly(vinylidene chloride), polytetrafluoroethylene, polyisoprene, polyacrylamide, polyacrylic acid, polymethacrylate, polyacetals or mixtures thereof.

The adhesive/sealant material may include an acrylate copolymer, an acetate copolymer or both. The adhesive/sealant material may include ethylene methyl acrylate (EMA), ethylene vinyl acetate (EVA) or a combination thereof. When included, EMA is typically between about 1% and about 70%, more typically between about 30% and about 60% and even more typically between about 44% and about 55% by weight of the adhesive/sealant material. A desirable EMA can have a melt index between about 110 and about 150 grams/10 min. (e.g., about 135 grams/10 min.). When included, EVA is typically between about 1% and about 70%, more typically between about 2% and about 10% and even more typically between about 3% and about 5% by weight of the melt flow material.

It is also contemplated that the adhesive/sealant material can include one or more isocyanate reactive ingredients (e.g., polyols), which can be reactive with blocked isocyanates. Example of such ingredients and isocyanates are disclosed in U.S. Patent Application, Publication No. 2005/0320027, which is incorporated herein by reference for all purposes.

It is also possible that the adhesive/sealant material can also include one or more materials for controlling the rheological characteristics of the adhesive/sealant material over a range of temperatures (e.g., up to about 250° C. or greater). Any suitable art-disclosed rheology modifier may be used, and thus the rheology modifier may be organic or inorganic, liquid or solid, or otherwise. The rheology modifier may be a polymer, and more preferably one based upon an olefinic (e.g., an ethylene, a butylenes, a propylene or the like), a styrenic (e.g., a styrene-butadiene-containing rubber), an acrylic or an unsaturated carboxylic acid or its ester (such as acrylates, methacrylates or mixtures thereof; e.g., ethylene methyl acrylate (EMA) polymer) or acetates (e.g., EVA). The rheology modifier may be provided in a generally homogeneous state or suitably compounded with other ingredients. It is also contemplated that the various clays, minerals or other materials discussed in relation to fillers below can be employed to modify rheology of the adhesive/sealant material.

As discussed above, the material may be manufactured to include one or more physical or chemical blowing agents. It is possible that such blowing agents are activated during the manufacturing process such that a material including microcellular structures is formed upon initial formation (e.g. during or shortly before or after an extrusion process). However, it is also possible that the adhesive/sealant material may include additional blowing agents to cause expansion of the material at a later time (e.g., upon exposure to a predetermined stimulus). Thus, a material including microcellular structures may be activatable to foam and form additional cellular or microcellular structures post-manufacture. It is also possible that the material may be free of any additional blowing agent. For purposes of this disclosure, any blowing agent included for downstream foaming (e.g., post-manufacturing via extrusion, molding or the like) will be considered a “secondary blowing agent”.

When utilized, the secondary blowing agent typically produces inert gasses that form as desired an open and/or closed cellular structure within the adhesive/sealant material. In this manner, it may be possible to lower the density of articles fabricated from the adhesive/sealant material. In addition, the material expansion can help to improve sealing or wetting capability.

The secondary blowing agent may include one or more nitrogen containing groups such as amides, amines and the like. In a one embodiment, modified and unmodified azocarbonamides may be supplied to the material in particle form having particles sizes of, for example, 120 and 180 microns. Advantageously, the azocarbonamides can assist the adhesive/sealant material in leveling itself (i.e., forming a surface of maintaining the surface in a substantially flat condition). It is also possible that the adhesive/sealant material is substantially free of any azodicarbonamide.

An accelerator for the secondary blowing agents may also be provided in the adhesive/sealant material. Various accelerators may be used to increase the rate at which the blowing agents form inert gasses. One preferred blowing agent accelerator is a metal salt, and/or is an oxide, e.g. a metal oxide, such as zinc oxide.

Amounts of secondary blowing agents and blowing agent accelerators can vary widely within the adhesive/sealant material depending upon the type of cellular structure desired, the desired extent of expansion of the adhesive/sealant material, the desired rate of expansion and the like. Exemplary ranges for the amounts of blowing agents and blowing agent accelerators in the adhesive/sealant material range from about 0% by weight to about 5% by weight and are preferably in the adhesive/sealant material in fractions of weight percentages.

The adhesive/sealant material may also include one or more curing agents and/or curing agent accelerators. Amounts of curing agents and curing agent accelerators can, like the blowing agents, vary widely within the adhesive/sealant material depending upon the type of cellular structure desired, the desired extent of expansion of the adhesive/sealant material, the desired rate of expansion, the desired structural properties of the adhesive/sealant material and the like. Exemplary ranges for the curing agents, curing agent accelerators or both present in the adhesive/sealant material range from about 0% by weight to about 7% by weight.

Preferably, the curing agents assist the adhesive/sealant material in curing by crosslinking of the polymers, epoxy resins or both. It is also preferable for the curing agents to assist in thermosetting the adhesive/sealant material, though thermoplastic materials are also envisioned. Useful classes of curing agents are materials selected from aliphatic or aromatic amines or their respective adducts, amidoamines, polyamides, cycloaliphatic amines (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like)), or mixtures thereof. Particular preferred curing agents include modified and unmodified polyamines such as triethylenetetramine, diethylenetriamine tetraethylenepentamine, cyanoguanidine and the like. An accelerator for the curing agents (e.g., methylene diphenyl bis urea) may also be provided for preparing the adhesive/sealant material.

Other preferred curing agents can include peroxides, such as bis(t-butylperoxy)diisopropylbenzene, 1,1-di-t-butylperoxy-3,3,5-trimethylcyclohexane, 4,4-di-t-butylperoxy n-butyl valerate, dicumyl peroxide, and the like. It may also be desirable for one or more of the curing agents to be higher temperature curing agents. Such a curing agent is typically configured to cure and or crosslink polymers of the adhesive/sealant material at a temperature that is at least 120° C., more typically at least 170° C. and possibly at least 200° C.

The adhesive/sealant material may also include one or more fillers e.g., reinforcing components, including but not limited to particulated materials (e.g., powder), beads, microspheres, or the like. These reinforcing components may interact with one or more of the primary or secondary blowing agents. As mentioned above, the addition of certain reinforcing components may enable the use of lower percentages of blowing agent. More specifically, the addition of certain reinforcing components may enable the use of lower percentages of the primary blowing agent. Preferably the reinforcing component includes a relatively low-density material that is generally non-reactive with the other components present in the adhesive/sealant material.

Examples of such reinforcing components include silica, diatomaceous earth, glass, clay, talc, pigments, colorants, glass beads or bubbles, glass, carbon ceramic fibers, antioxidants, and the like. Such reinforcing components, particularly clays, can assist the adhesive/sealant material in leveling itself during flow of the material. The clays that may be used as reinforcing components may include clays from the kaolinite, illite, chloritem, smecitite or sepiolite groups. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The reinforcing components may also include ammonium chlorides such as dimethyl ammonium chloride and dimethyl benzyl ammonium chloride. Titanium dioxide might also be employed. It is also possible that one or more mineral or stone type fillers such as calcium carbonate, sodium carbonate or the like may be used as fillers. Silicate minerals such as mica may be used as fillers. It has been found that, in addition to performing the normal functions of a filler, silicate minerals and mica in particular can assist in leveling the adhesive/sealant material.

When employed, the fillers in the adhesive/sealant material can range from about 10% to 90% by weight of the adhesive/sealant material. According to some embodiments, the adhesive/sealant material may include from about 0% to about 3% by weight, and more preferably slightly less than 1% by weight clays or similar fillers. Powdered (e.g. about 0.01 to about 50, and more preferably about 1 to 25 micron mean particle diameter) mineral type filler can comprise between about 5% and 70% by weight, more preferably about 40% to about 60%, and still more preferably approximately 55% by weight of the adhesive/sealant material.

It is also possible that one or more phenoxy resins may be included in the adhesive/sealant material. Phenoxy resins are high molecular weight thermoplastic condensation products of bisphenol A and epichloro-hydrin and their derivatives. Modified phenoxy resins may also be used. Examples of suitable materials are the PKHB, PKHC, PKHH, PKHJ, PKHP pellets and powder. Alternatively phenoxy/polyester hybrids and epoxy/phenoxy hybrids may be used. In order to enhance the production of the activatable material it is possible that the phenoxy resin be supplied to the other components as a solution. While any solvent may be used it is particularly preferred to use a liquid epoxy resin as the solvent as this can also contribute to the adhesive/sealant properties upon activation. When the adhesive/sealant is to be applied as a past we prefer to use no more than 20% by weight of the phenoxy resin as higher amounts can result in too high a viscosity. However, higher percentages are effective for materials that are solid prior to activation.

A core/shell polymer material may also be included in the adhesive/sealant. As used herein, the term core/shell polymer denotes a polymeric material wherein a substantial portion (e.g., greater than 30%, 50%, 70% or more by weight) thereof is comprised of a first polymeric material (i.e., the first or core material) that is substantially entirely encapsulated by a second polymeric material (i.e., the second or shell material). The first and second polymeric materials, as used herein, can be comprised of one, two, three or more polymers that are combined and/or reacted together (e.g., sequentially polymerized) or may be part of separate or same core/shell systems. The core/shell polymer should be compatible with the formulation and preferably has a ductile core and a rigid shell which is compatible with the other components of the adhesive/sealant formulation.

The first and second polymeric materials of the core/shell polymer can include elastomers, polymers, thermoplastics, copolymers, other components, combinations thereof or the like. In preferred embodiments, the first polymeric material, the second polymeric material or both include or are substantially entirely composed of (e.g., at least 70%, 80%, 90% or more by weight) one or more thermoplastics. Exemplary thermoplastics include, without limitation, styrenics, acrylonitriles, acrylates, acetates, polyamides, polyethylenes or the like.

Preferred core/shell polymers are formed by emulsion polymerization followed by coagulation or spray drying. It is also preferred for the core/shell polymer to be formed of or at least include a core-shell graft co-polymer. The first or core polymeric material of the graft copolymer preferably has a glass transition temperature substantially below (i.e., at least 10, 20, 40 or more degrees centigrade) the glass transition temperature of the second or shell polymeric material. Moreover, it may be desirable for the glass transition temperature of the first or core polymeric material to be below 23° C. while the glass temperature of the second or shell polymeric material to be above 23° C., although not required.

Examples of useful core-shell graft copolymers are those where hard containing compounds, such as styrene, acrylonitrile or methyl methacrylate, are grafted onto a core made from polymers of soft or elastomeric compounds such as butadiene or butyl acrylate. U.S. Pat. No. 3,985,703, describes useful core-shell polymers, the cores of which are made from butyl acrylate but can be based on ethyl isobutyl, 2-ethylhexyl or other alkyl acrylates or mixtures thereof. The core polymer, may also include other copolymerizable containing compounds, such as styrene, vinyl acetate, methyl methacrylate, butadiene, isoprene, or the like. The core polymer material may also include a cross linking monomer having two or more nonconjugated double bonds of approximately equal reactivity such as ethylene glycol diacrylate, butylene glycol dimethacrylate, and the like. The core polymer material may also include a graft linking monomer having two or more nonconjugated double bonds of unequal reactivity such as, for example, diallyl maleate and allyl methacrylate.

The shell portion is preferably polymerized from methyl acrylates such as methyl methacrylate and optionally other alkyl acrylates and methacrylates, such as ethyl, butyl, or mixtures thereof acrylates or methacrylates as these materials are compatible with the phenoxy resin and any epoxy resins that are used in the formulation. Up to 40% by weight or more of the shell monomers may be styrene, vinyl acetate, vinyl chloride, and the like. Additional core-shell graft copolymers useful in embodiments of the present invention are described in U.S. Pat. Nos. 3,984,497; 4,096,202; 4,034,013; 3,944,631; 4,306,040; 4,495,324; 4,304,709; and 4,536,436, all of which are incorporated by reference herein for all purposes. Examples of core-shell graft copolymers include, but are not limited to, “MBS” (methacrylate-butadiene-styrene) polymers, which are made by polymerizing methyl methacrylate in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

The adhesive/sealant may include one or more additional polymers or copolymers, which can include a variety of different polymers, such as thermoplastics, elastomers, plastomers and combinations thereof. For example, and without limitation, polymers that might be appropriately incorporated into the adhesive/sealant include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate. And mixtures thereof.

When used, these polymers can comprise a small portion or a more substantial portion of the material. When used, the one or more additional polymers preferably comprises about 0.1% to about 50%, more preferably about 1% to about 20% and even more preferably about 2% to about 10% by weight of the adhesive/sealant material.

In certain embodiments, it may be desirable to include one or more thermoplastic polyethers and/or thermoplastic epoxy resins in the adhesive/sealant material. When included, the one or more thermoplastic polyethers preferably comprise between about 1% and about 90% by weight of the adhesive/sealant material, more preferably between about 3% and about 60% by weight of the adhesive/sealant material and even more preferably between about 4% and about 25% by weight of the adhesive/sealant material. As with the other materials, however, more or less thermoplastic polyether may be employed depending upon the intended use of the adhesive/sealant material.

The thermoplastic polyethers typically include pendant hydroxyl moieties. The thermoplastic polyethers may also include aromatic ether/amine repeating units in their backbones. The thermoplastic polyethers may have a melt index between about 5 and about 100, more preferably between about 25 and about 75 and even more preferably between about 40 and about 60 grams per 10 minutes for samples weighing 2.16 Kg at a temperature of about 190° C. Of course, the thermoplastic polyethers may have higher or lower melt indices depending upon their intended application. Preferred thermoplastic polyethers include, without limitation, polyetheramines, poly(amino ethers), copolymers of monoethanolamine and diglycidyl ether, combinations thereof or the like.

Preferably, the thermoplastic polyethers are formed by reacting an amine with an average functionality of 2 or less (e.g., a difunctional amine) with a glycidyl ether (e.g., a diglycidyl ether). As used herein, the term difunctional amine refers to an amine with an average of two reactive groups (e.g., reactive hydrogens).

Additionally, it is contemplated that amines (e.g., cyclic amines) with one reactive group (e.g., one reactive hydrogen) may be employed for forming the thermoplastic polyether. Advantageously, such amines may assist in controlling the molecular weight of the thermoplastic ether formed.

Other additives, agents or performance modifiers may also be included in the adhesive/sealant material as desired, including but not limited to a UV resistant agent, a flame retardant, an impact modifier, an adhesion promoter, a heat stabilizer, a colorant, a processing aid, a lubricant, a reinforcement (e.g., chopped or continuous glass, ceramic, aramid, or carbon fiber or the like). One preferred additive is an adhesion promoter such as a hydrocarbon resin. Another preferred additive is a coagent such an acrylate coagent.

Once formed, the adhesive/sealant material typically has a melt temperature less than about 200° C., more typically less than about 140° C. and even more typically less than about 100° C., but typically greater than about 30° C., more typically greater than about 50° C. and even more typically greater than about 65° C., although higher or lower melt temperatures are possible depending upon the manner of application of the adhesive/sealant material. The adhesive/sealant material also typically has a glass transition temperature that is less than about 20° C., more typically less than about 0° C. and even more typically less than about −20° C., but typically greater than about −100° C., more typically greater than about −60° C. and even more typically greater than about −40° C., although higher or lower glass transition temperatures are possible depending upon the manner of application of the adhesive/sealant material.

When determining appropriate components for the adhesive/sealant material, it may be important to form the material such that it will only activate (e.g., flow, foam or otherwise change states) at appropriate times or temperatures. For instance, in some applications, it is undesirable for the material to be reactive at room temperature or otherwise at the ambient temperature in a production environment. More typically, the adhesive/sealant material becomes activated to flow at higher processing temperatures. As an example, temperatures such as those encountered in an automobile assembly plant may be appropriate, especially when the adhesive/sealant material is processed along with the other components at elevated temperatures or at higher applied energy levels, e.g., during painting preparation steps. Temperatures encountered in many coating operations (e.g., in a paint and/or e-coat curing oven), for instance, range up to about 250° C. or higher.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A material, comprising:
a primary blowing agent for causing the formation of cellular structures within the material during an initial manufacturing process;
a secondary blowing agent for causing the formation of cellular structures within the material after the initial manufacturing process.

2. A material comprising:
a primary blowing agent for causing the formation of cellular structures within the material during an initial manufacturing process;
an epoxy material; and
a curing agent.

3. The material of claim 2, including a secondary blowing agent that is activated by a selected stimulus.

4. The material of claim 1, wherein the primary blowing agent is limited to physical blowing agents and is free of any chemical blowing agents.

5. The material of claim 2, wherein the primary blowing agent is limited to physical blowing agents and is free of any chemical blowing agents.

6. The material of claim 1, wherein the primary blowing agent is selected from hydrocarbons, chlorofluorocarbons, nitrogen, carbon dioxide, and combinations thereof.

7. The material of claim 2, wherein the primary blowing agent is selected from hydrocarbons, chlorofluorocarbons, nitrogen, carbon dioxide, and combinations thereof.

8. The material of claim 1, wherein the initial manufacturing process is an extrusion process.

9. The material of claim 1, wherein the primary blowing agent is less than about 10%, less than about 5%, or even less than about 2.5% by weight of the material.

10. The material of claim 2, wherein the primary blowing agent is less than about 10%, less than about 5%, or even less than about 2.5% by weight of the material.

11. The material of claim 2, including a secondary blowing agent that is a chemical blowing agent.

12. The material of claim 11, wherein the secondary blowing agent is selected from azodicarbonamide, dinitrosopentamethylenetetramine, azodicarbonamide, dinitrosopentamethylenetetramine, 4,4ioxy-bis-(benzenesulphonylhydrazide), trihydrazinotriazine and N,Ni-dimethyl-N,Nidinitrosoterephthalamide and combinations thereof.

13. The material of claim 1, including a toughening agent that is a core shell material.

14. The material of claim 2, including a toughening agent that is a core shell material.

15. A material for sealing or structural reinforcement or some combination thereof, comprising:
a primary blowing agent for imparting cellular structures within the material during initial manufacturing of the material;
a polymeric base material that has adhesive characteristics, sealing characteristics, or some combination thereof;
a curing agent for curing the material via a stimulus;
optionally a secondary blowing agent for forming additional cellular structures within the material.

16. The material of claim 15, wherein the polymeric base material is an epoxy-based material.

17. The material of claim 15, wherein the polymeric base material is an ethylene-based material.

18. The material of claim 15, wherein the primary blowing agent is a physical blowing agent.

19. The material of claim 15, wherein the secondary blowing agent is a chemical blowing agent.

20. The material of claim 15, wherein the secondary blowing agent is a physical blowing agent.
